(19) United States
(12) Patent Application Publication
(10) Pub. No.: US 2006/0135023 A1
(43) Pub. Date: Jun. 22, 2006

(54) High loft flame resistant batting for mattresses and furniture and processes for making same

(76) Inventor: Warren F. Knoff, Richmond, VA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/017,069

(22) Filed: Dec. 20, 2004

(51) Int. Cl. B32B 5/26; D04H 13/00; D04H 3/00; B32B 27/02; D04H 1/00; D04H 5/00

(52) U.S. Cl. 442/392; 442/381; 442/414; 442/416; 428/921

(57) ABSTRACT

This invention relates to a high loft flame resistant batting comprising fibers and a thermoplastic binder, and an article or mattress containing the high loft flame resistant batting, the batting having a thermal performance temperature (TPT) in degrees Celsius represented by the equation:
TPT</=380−0.326×(total basis weight) wherein the basis weight is given in grams per square meter.

### BACKGROUND OF THE INVENTION

1. Field of the Invention

This invention relates to a layered high loft flame resistant batting that is especially useful in fire-blocking an article such as a foam-core or a foam-encased mattress, particularly the gussets and borders of a foam mattress and processes for making the batting and methods of fire-blocking articles.

2. Description of Related Art

The State of California has led the drive to regulate and reduce the flammability of mattresses and mattress sets in an attempt to reduce the number of lives lost in household, hotel, and institutional fires. In particular, the Bureau of Home Furnishings and Thermal Insulation of the Department of Consumer Affairs of the State of California issued Technical Bulletin 603 “Requirements and Test Procedure for Resistance of a Residential Mattress/Box Spring Set to a Large Open-Flame” to quantify the flammability performance of mattress sets. One measure of screening fabrics to determine suitability as fire blockers is by use of a test that measures thermal performance temperature (TPT) of the fabric, which is a value that is directly proportional to the amount of heat that passes through the barrier fabric. Low TPT values mean the fire blocker is a good insulator from flame and will help prevent the internals of a mattress from the heat from an external flame.

There are several ways to incorporate a fire barrier into a mattress, however, it is preferred that one of the existing layers of material in a mattress be converted to one that can act as a fire blocking layer. In particular, since most mattresses have a high loft fiber batting, and this batting can provide additional fuel if made from flammable materials, replacing this high loft material with another material that can act as a fire blocker is a preferred solution.

The selection of the specific materials to be used in the fire-blocking high loft batting therefore becomes very important. Some fiber materials have more fire-resistance per unit weight than others, and generally fibers having more fire-resistance are more expensive than fibers having less fire-resistance. One can compensate for fibers having less fire-resistance by simply increasing the amount of fiber used, thereby increasing both the basis weight and thickness of the fire blocker. This not an adequate solution, however, because if excessive amounts of fiber are used, this can cause other problems associated with sewing the high loft batting into the mattress cover and closing the mattress cover during fabrication. A better approach is to engineer a fire blocker fabric so that excessive amounts of fiber are not needed and therefore the fabric performs as a fire blocker at a relatively lower basis weight.

The PCT Publication WO 03/023108 of Mater et al. discloses a nonwoven high loft flame barrier for use in mattresses and upholstered furniture. These barriers have very low density, ranging from 5 to 50 kilograms per cubic meter, most preferably 7.5 to 15 kilograms per cubic meter. The preferred nonwoven high loft flame barrier comprises a blend of fibers including fibers that are inherently fire resistant and resistant to shrinkage by direct flame, and fibers from polymers made with halogenated monomers.

United States Patent Application Publications US2004/0060119 discloses a fire barrier fabric having a fire barrier layer and a thermally insulating layer. The fire barrier layer can be composed of a blend of aramid and modacrylic fibers and the thermally insulating layers can be composed of FR viscose and modacrylic fibers.

These patent applications disclose many types of fabrics but do not disclose any desired relationship between the thermal performance temperature of the fabric and the desired basis weight of the fabric. Therefore, what is needed is a high loft fire blocker for mattresses and upholstery having both a low thermal performance temperature and a low basis weight.

### SUMMARY OF THE INVENTION

This invention relates to a high loft flame resistant batting comprising fibers and a thermoplastic binder, and an article or mattress containing the high loft flame resistant batting, the batting having a thermal performance temperature (TPT) in degrees Celsius represented by the equation:
TPT</=380−0.326×(total basis weight)
wherein the basis weight is given in grams per square meter.

This invention also relates to a method of fire blocking an article, comprising the steps of combining a layer of a fabric ticking or upholstery, and a high loft flame resistant batting, and optionally a stitch backing layer, the high loft batting comprising fibers, the batting having a thermal performance temperature (TPT) in degrees Celsius represented by the equation
TPT</=380−0.326×(total basis weight)
wherein the basis weight is given in grams per square meter, the batting typically having a total thickness of at least 0.5 inches (1.25 centimeters), sewing the layers together to form a fire blocked quilted composite or upholstery fabric, and incorporating the fire blocked quilted composite or upholstery fabric into the article.

One embodiment of this invention relates to a layered high loft flame resistant batting comprising a base layer and an outer layer and an article such as a mattress containing such batting. The base layer of the batting comprises 30 to 80 parts by weight heat resistant fibers, 5 to 55 parts by weight of a cellulose fiber that retains at least 10 percent of its fiber weight when heated in air to 700° C. at a rate of 20 degrees C. per minute, and a first binder material. The outer layer comprises a second binder material and up to 85 parts by weight of a fiber that is either (i) a cellulose fiber that retains at least 10 percent of its fiber weight when heated in air to 700° C. at a rate of 20 degrees C. per minute, (ii) a modacrylic fiber, or (iii) mixtures including these two fibers. In the high loft batting, the base layer comprises 20 to 70 parts by weight and the outer layer comprises 80 to 30 parts by weight, based on the total weight of those two layers, and the batting has a total thickness of 0.5 inches (1.25 centimeters) or greater.

This invention further relates to a method of fire blocking an article comprising the steps of:

a) combining a layer of a fabric ticking or upholstery, a high loft batting, and optionally a stitch backing layer, the high loft batting comprising
i) a base layer comprising 30 to 80 parts by weight heat resistant fibers, 5 to 55 parts by weight of a cellulose fiber that retains at least 10 percent of its fiber weight when heated in air to 700° C. at a rate of 20 degrees C. per minute, and a first binder material; and
ii) an outer layer comprising up to 85 parts by weight of fiber that is either a cellulose fiber that retains at least 10 percent of its fiber weight when heated in air to 700° C. at a rate of 20 degrees C. per minute, a modacrylic fiber, or mixtures including these two fibers, and a second binder material; the base layer comprising 20 to 70 parts by weight and the outer layer comprising 80 to 30 parts by weight of the batting, based on the total weight of those two layers, the batting having a total thickness of at least 0.5 inches (1.25 centimeters),

b) sewing the layers together to form a fire blocked quilted composite or upholstery fabric, and

c) incorporating the fire blocked quilted composite or upholstery fabric into the article.

### BRIEF DESCRIPTION OF FIGURES

FIG. 1 is a representation of the relationship of TPT to basis weight for the high loft flame resistant batting of this invention

FIG. 2 is a representation of preferred high loft battings of this invention.

### DETAILS OF THE INVENTION

TPT Batting

This invention relates to a high loft flame resistant batting having a thermal performance temperature (TPT) in degrees Celsius represented by the equation:
TPT</=380−0.326×(total basis weight)
wherein the basis weight is given in grams per square meter. The TPT is a measure of the thermal insulating performance of the barrier materials. The lower the TPT value, the better the thermal insulating performance of the material.

The battings of this invention have a preferred total density of 0.3 to 4.3 pounds per cubic foot (5 to 70 kilograms per cubic meter). Denser battings generally do not have the resiliency desired for use as cushioning in mattresses and other articles. Battings that are less dense than the desired ranges are bulky to handle during fabrication and are generally compressed into the preferred density range when incorporated into a quilted composite. Thinner and denser battings also do not provide the desired softness and esthetics.

The high loft battings of this invention also have a preferred total thickness of 0.5 inches (1.25 centimeters) or greater. While there is no real limitation on how thick the batting can be, for many typical applications, the thickness of the high loft batting need not be higher than 3 inches (7.6 cm), and for many mattress applications less than 2 inches (5 cm) is very useful. The battings of this invention also generally have a basis weight of about 8 to 18 ounces per square yard (271 to 610 grams per square meter) and are preferably 11 to 16 ounces per square yard (373 to 542 grams per square meter).

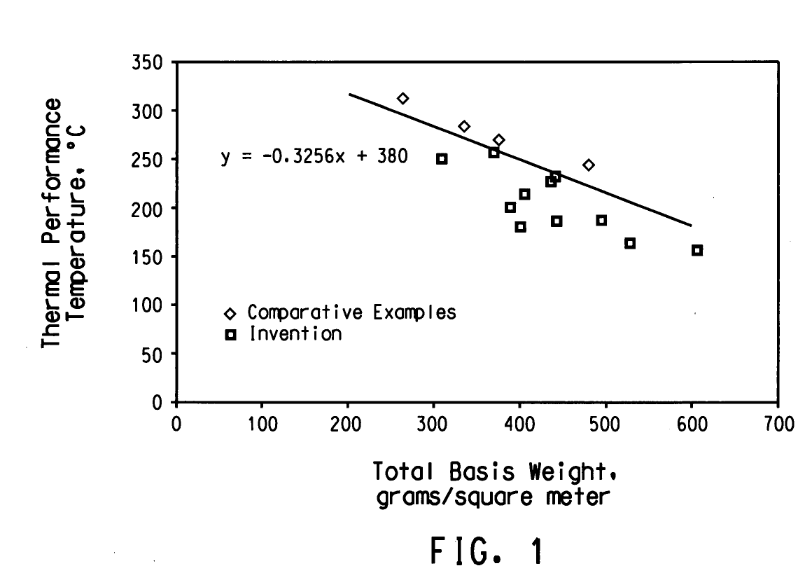

FIG. 1 is a representation of the relationship of TPT to basis weight for the high loft flame resistant batting of this invention. The upper relationship is illustrative of the comparative examples of the prior art. The lower relationship is illustrative of the examples of the battings of this invention. These FR high loft barriers have high thermal insulating performance (lower TPT) at a given basis weight.

The high loft flame resistant battings of this invention comprise heat resistant fiber. By “heat resistant fiber” it is meant that the fiber preferably retains 90 percent of its fiber weight when heated in air to 500° C. at a rate of 20 degrees C. per minute. Such fiber is normally flame resistant, meaning the fiber or a fabric made from the fiber has a Limiting Oxygen Index (LOI) such that the fiber or fabric will not support a flame in air, the preferred LOI range being about 26 and higher. The preferred fibers do not excessively shrink when exposed to a flame, that is, the length of the fiber will not significantly shorten when exposed to flame. Fabrics containing an organic fiber that retains 90 percent of its fiber weight when heated in air to 500° C. at a rate of 20 degrees C. per minute tend to have limited amount of cracks and openings when burned by an impinging flame, which is important to the fabric's performance as a fire blocker.

Heat resistant and stable fibers useful in the nonwoven fire-blocking fabric of this invention include fiber made from para-aramid, polybenzazole, polybenzimidazole, and polyimide polymer. The preferred heat resistant fiber is made from aramid polymer, especially para-aramid polymer.

As used herein, “aramid” is meant a polyamide wherein at least 85% of the amide (—CONH—) linkages are attached directly to two aromatic rings. “Para-aramid” means the two rings or radicals are para oriented with respect to each other along the molecular chain. Additives can be used with the aramid. In fact, it has been found that up to as much as 10 percent, by weight, of other polymeric material can be blended with the aramid or that copolymers can be used having as much as 10 percent of other diamine substituted for the diamine of the aramid or as much as 10 percent of other diacid chloride substituted for the diacid chloride of the aramid. In the practice of this invention, the preferred para-aramid is poly(paraphenylene terephthalamide). Methods for making para-aramid fibers useful in this invention are generally disclosed in, for example, U.S. Pat. Nos. 3,869,430, 3,869,429, and 3,767,756. Such aromatic polyamide organic fibers and various forms of these fibers are available from DuPont Company, Wilmington, Del. under the trademark Kevlar® fibers.

Commercially available polybenzazole fibers useful in this invention include Zylon® PBO-AS (Poly(p-phenylene-2,6-benzobisoxazole) fiber, Zylon® PBO-HM (Poly(p-phenylene-2,6-benzobisoxazole)) fiber, available from Toyobo, Japan. Commercially available polybenzimidazole fibers useful in this invention include PBI® fiber available from Celanese Acetate LLC. Commercially available polyimide fibers useful in this invention include P-84® fiber available from LaPlace Chemical.

The high loft flame resistant battings of this invention can also comprise a cellulose fiber that retains at least 10 percent of its fiber weight when heated in air to 700° C. at a rate of 20 degrees C. per minute. These fibers are said to be char forming. The cellulose fibers used in the composite of this invention are preferably regenerated cellulose fibers have 10 percent or more inorganic compounds incorporated into the fibers. Such fibers, and methods for making such fibers, are generally disclosed in U.S. Pat. No. 3,565,749 and British Patent No. 1,064,271. A preferred char-forming regenerated cellulose fiber for this invention is a viscose fiber containing hydrated silicon dioxide in the form of a polysilicic acid with aluminum silicate sites. Such fibers, and methods for making such fibers are generally disclosed in U.S. Pat. No. 5,417,752 and PCT Pat. Appl. WO9217629. Viscose fiber containing silicic acid and having approximately 31 (±3) percent inorganic material is sold under the trademark Visil® by Sateri Oy Company of Finland.

Method of Fire Blocking an Article and Fire Blocked Article

This invention also includes a fire blocked article comprising the high loft batting described herein. The articles that can be fire blocked include such things as upholstered cushions and furniture. Preferably however, the fire blocked article is a mattress comprising a quilted composite incorporating the high loft web batting. The mattress quilted composite can be formed by combining layers of ticking fabric, one or more layers of the high loft batting, optionally foam and combustible fiber batting, and if needed, a scrim backing, which is used on the side of the mattress quilted composite that will be facing the mattress internals.

The ticking fabric is normally a very durable woven or knit fabric utilizing any number of weaves, and tends to have basis weights in the range of 2 to 8 ounces per square yard (68 to 271 grams per square meter). Typical ticking fabrics may contain but are not limited to cotton, polyester fibers, or rayon fibers. The foam is typically polyurethane foam. The scrim backing is generally a layer of a 0.5 to 1 ounces per square: yard (17 to 39 grams per square meter) nonwoven (generally spunbonded) fabric. The layers of the mattress quilted composite panel can be securely bound together by lines of stitching with thread This invention further relates to a method of fire blocking an article, and such a method can comprise the steps of:
a) combining a layer of a fabric ticking or upholstery, and a high loft batting, and optionally a stitch backing layer, the high loft batting comprising fibers, the batting having a thermal performance temperature (TPT) in degrees Celsius:
   TPT</=380−0.326(total basis weight)
   wherein the basis weight is given in grams per square meter, the batting having a total thickness of at least 0.5 inches (1.25 centimeters),
b) sewing the layers together to form a fire blocked quilted composite or upholstery fabric, and
c) incorporating the fire blocked quilted composite or upholstery fabric into the article.

The high loft batting of this invention can be incorporated mattresses, foundations, and/or box springs as a flame blocking layer. For example, the panels and the borders of mattresses, foundations, and/or box springs can utilize the previously described mattress panel quilted composite or any other variant that incorporates as a component the layered high loft batting of this invention. The barriers of this invention are most valuable in places where high thermal insulating performance is need such as the borders and gussets of foam core mattresses. The stitching can be sewn with non-flame retardant thread, however, a fire- retardant thread, such as one made from Kevlar® aramid fiber, is preferred for the stitching, especially for stitching of the borders of the mattresses, foundations, and/or box springs.

Specific Layered High Loft Batting

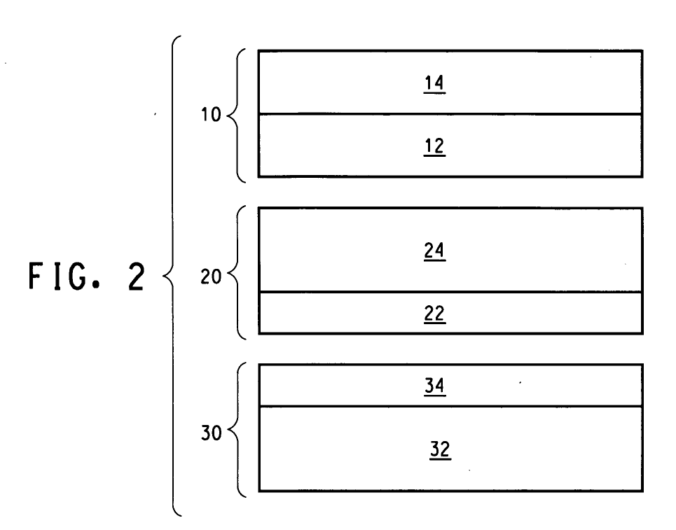

One embodiment of this invention relates to a layered high loft flame resistant batting, and an article such as a mattress containing such batting. FIG. 2 illustrates simplified cross sections of some representative layered battings that work together to form a fire blocking material. Layered batting 10 comprises base layer 12 and outer layer 14 wherein the layers have similar thickness. Layered batting 20 comprises base layer 22 and outer layer 24 wherein the outer layer is thicker than the base layer. Layered batting 30 comprises base layer 32 and outer layer 34 wherein the base layer is thicker than the outer layer.

The base layer comprises 30 to 80 parts by weight heat resistant fibers, 5 to 55 parts by weight of a cellulose fiber that retains at least 10 percent of its fiber weight when heated in air to 700° C. at a rate of 20 degrees C. per minute, and a first binder material; the outer layer comprises a second binder material and up to 85 parts by weight of a fiber that is either a cellulose fiber that retains at least 10 percent of its fiber weight when heated in air to 700° C. at a rate of 20 degrees C. per minute, or a modacrylic fiber, or a blend of these fibers. In the layered high loft batting, the base layer is present in an amount of 20 to 70 parts by weight and the outer layer is present in an amount of 80 to 30 parts by weight, based on the total weight of the base and outer layers.

The base layer of the layered high loft batting contains 30 to 80 parts by weight heat resistant fibers, 5 to 55 parts by weight of a cellulose fiber that retains at least 10 percent of its fiber weight when heated in air to 700° C. at a rate of 20 degrees C. per minute, and 15 to 25 parts by weight binder material. Preferably, the heat resistant fibers are present in the amount of 25 to 35 parts by weight; the cellulose fibers are present in the amount of 45 to 55 parts by weight. The base layer provides a dense structure that forms a char and maintains integrity in flame.

The base layer of the layered high loft batting also contains 5 to 55 parts by weight of also comprise a cellulose fiber that retains at least 10 percent of its fiber weight when heated in air to 700° C. at a rate of 20 degrees C. per minute. As disclosed previously herein, a preferred char-forming regenerated cellulose fiber is a viscose fiber containing hydrated silicon dioxide in the form of a polysilicic acid with aluminum silicate sites such as that sold under the trademark Visil® by Sateri Oy Company of Finland.

The base layer of the layered high loft batting also contains a first binder material, preferably present in an amount of 15 to 25 parts by weight based on the amount of fiber and binder present in the base layer. The preferred binder material is a binder fiber that is activated by the application of heat. Such binder fibers are typically made from a thermoplastic material that flows at a temperature that is lower (i.e., has a softening point lower) than the softening point of any of the other staple fibers in the fiber blend. Sheath/core bicomponent fibers are preferred as binder fibers, especially bicomponent binder fibers having a core of polyester homopolymer and a sheath of copolyester that is a binder material, such as are commonly available from Unitika Co., Japan (e.g., sold under the trademark MELTY®). Useful types of binder fibers can include those made from polypropylene, polyethylene, or polyester polymers or copolymers, the fibers containing only that polymer or copolymer, or as a bicomponent fiber in side-by-side or sheath/core configuration.

The outer layer of the layered high loft batting contains a second binder material and up to 85 parts by weight of a fiber that is either a cellulose fiber that retains at least 10 percent of its fiber weight when heated in air to 700° C. at a rate of 20 degrees C. per minute, a modacrylic fiber, or a mixture or blend including these fibers. The second binder material is preferably present in an amount of 15 to 25 parts by weight binder material. As in the base layer, the preferred binder material is a binder fiber that is activated by the application of heat. Generally the same binder can be used for both the outer and base layers, however, this is not a requirement.

The outer layer preferably functions as the outer layer of the layered high loft batting, providing an outer structure that chars in flame and off-gasses to suppress flames. The outer layer is typically white or light in color and also preferably shields any coloring of the base layer. Such types of outer layers are particularly useful in fire blocking highly flammable mattresses and furniture, especially those that contain high quantities of foam. Such mattresses are difficult to fire block, especially the border areas and any gusset areas the mattresses may have.

If the outer layer comprises a cellulose fiber that retains at least 10 percent of its fiber weight when heated in air to 700° C. at a rate of 20 degrees C. per minute, that fiber is preferably present in an amount of 35 to 45 parts by weight of the outer layer. If more than 80 parts by weight of such fibers are used, there is insufficient binder fiber and the durability of the outer layer may be compromised. If less than 20 parts by weight of such fibers is used, it is believed that the outer layer does not have sufficient char to provide adequate fire blocking for foam mattresses.

If desired, a fiber that releases a flame-suppressing gas can be included in the outer layer. Modacrylic fiber is a preferred such fiber because this fiber releases flame-suppressing halogen-containing gases when burned. If the outer layer comprises a modacrylic fiber, that fiber is preferably present in an amount of 35 to 45 parts by weight of the outer layer. If more than 80 parts by weight of modacrylic fibers are used in the outer layer, there is insufficient binder fiber and the durability of the outer layer may be compromised. From a practical standpoint, if significant flame-suppressing off gassing is desired from the outer layer, it is thought that at least 20 parts by weight of the modacrylic fiber are needed in that layer.

By modacrylic fiber it is meant acrylic synthetic fiber made from a polymer comprising acrylonitrile. Preferably the polymer is a copolymer comprising 30 to 70 weight percent of an acrylonitrile and 70 to 30 weight percent of a halogen-containing vinyl monomer. The halogen-containing vinyl monomer is at least one monomer selected, for example, from vinyl chloride, vinylidene chloride, vinyl bromide, vinylidene bromide, etc. Examples of copolymerizable vinyl-monomers are acrylic acid, methacrylic acid, salts or esters of such acids, acrylamide, methylacrylamide, vinyl acetate, etc.

The preferred modacrylic fibers used in this invention are copolymers of acrylonitrile combined with vinylidene chloride. The copolymer can have, in addition, an antimony oxide or antimony oxides for improved fire retardancy. Such useful modacrylic fibers include, but are not limited to, fibers disclosed in U.S. Pat. No. 3,193,602 having 2 weight percent antimony trioxide, fibers disclosed in U.S. Pat. No. 3,748,302 made with various antimony oxides that are present in an amount of at least 2 weight percent and preferably not greater than 8 weight percent, and fibers disclosed in U.S. Pat. Nos. 5,208,105 & 5,506,042 having 8 to 40 weight percent of an antimony compound. The preferred modacrylic fiber is commercially available from Kaneka Corporation, Japan, in various forms, some containing no antimony oxides while others such as Protex C are said to contain 10 to 15 weight percent of those compounds.

In the layered high loft batting, the base layer is present in an amount of 20 to 70 parts by weight and the outer layer is present in an amount of 80 to 30 parts by weight, based on the total weight of the base and outer layers. Preferably the base layer is present in an amount of 40 to 55 parts by weight and the outer layer is present in an amount of 60 to 45 parts by weight.

Process for Making Lavered Battings

The preferred process for making a high loft flame resistant batting, comprises the steps of:
a) forming a base layer fiber mixture comprising 30 to 80 parts by weight heat resistant fibers, 5 to 55 parts by weight of a cellulose fiber that retains at least 10 percent of its fiber weight when heated in air to 700° C. at a rate of 20 degrees C. per minute, and 15 to 25 parts by weight binder fibers;
b) forming an outer layer fiber mixture comprising up to 85 parts by weight of a fiber that is either a cellulose fiber that retains at least 10 percent of its fiber weight when heated in air to 700° C. at a rate of 20 degrees C. per minute or a modacrylic fiber, and 15 to 25 parts by weight binder fibers;
c) forming a layered batt having a total thickness of at least 1.25 centimeters (0.5 inches) wherein one layer contains the base layer fiber mixture and another layer contains the outer layer fiber mixture; and
d) heating the layered batt to activate the binder fibers and form a high loft batting.

The fiber mixtures and layered batt may be formed by any method that can create low-density webs. For example, clumps of crimped staple fibers and binder fibers obtained from bales of fiber can opened by a device such as a picker. Preferably these fibers are staple fibers having a linear density of about 0.5 to 100 denier per filament (0.55 to about 110 dtex per filament), preferably 0.8 to 50 denier/filament (0.88 to 56 dtex/filament) with the linear density range of about 0.9 to 30 denier/filament (1 to 33 dtex/filament) being most preferred. The fibers generally have a cut length of about 0.5 to 4 in (1.3 cm to 10.2 cm) and a preferred crimp frequency of about 6 to about 15 crimps/inch (2.4 to 5.9 crimps per cm).

The opened fiber mixture can be then blended by any available method, such as air conveying, to form a more uniform mixture. Alternatively, the fibers can be blended to form a uniform mixture prior to fiber opening in the picker. The blend of fibers can then be converted into a fibrous web by use of a device such as a card, although other methods, such as air-laying of the fibers may be used. The fibrous web can then be sent via conveyor to a device such as a crosslapper to create a high loft crosslapped structure by layering individual webs on top of one another in a zig-zig structure. The rate of fiber opening and crosslapping is controlled to create high loft crosslapped structures of the desired height. Representative processes useful in achieving crosslapped structures, including processes for crosslapping an air-laid or otherwise formed web on a belt or apron, are well known in the art and generally disclosed in U.S. Pat. No. 3,558,029 to Manns; U.S. Pat. No. 3,877,628 to Asselin et al.; U.S. Pat. No. 4,984,772 to Freund; U.S. Pat. No. 6,195,844 to Jourde et al., and British Patent Number 1,527,230 to Jowett.

To create a multilayered high loft batting of this invention, two or more high loft structures having different compositions, preferably the compositions of the aforementioned base and outer layers can be made either simultaneously or sequentially and then overlaid, one on the other, on a conveyor or belt. This layered high loft web batting is then set by applying heat, preferably by use of a heated oven and preferably without compression of the batting, to activate the binder material. The high loft batting is then cooled to set the binder material.

In the preferred process, the edges of the layered high loft batting are then trimmed to provide a batting with a uniform width. The portion of the high loft batting trimmed is then recycled back into the process, preferably by processing this material through a picker, which separates the trimmed edges into individual fibers. This recycled portion contains fibers from both the base and outer layers, and therefore to maintain the color consistency of the outer layer the recycled portion is preferably added to the base layer. Preferably, the total amount recycled to the base sheet is less than about 25 parts by weight of the total weight of the base sheet. Preferably, through this recycling process, the base layer can additionally contain cellulose fiber in an amount up to 15 parts by weight and modacrylic fiber in an amount up to 15 parts by weight of the base layer.

Method of Fire Blocking Articles with Layered Battings and the Fire Blocked Articles

This invention also includes a fire blocked article comprising the layered high loft batting described herein. As previously disclosed herein, the articles that can be fire blocked include such things as upholstered cushions and furniture, and are preferably a mattress comprising a quilted composite panel incorporating the high loft web batting.

This invention further relates to a method of fire blocking an article with the layered battings described herein, comprising the steps of:
a) combining a layer of a fabric ticking or upholstery, and a high loft batting, and optionally foam and combustible fiber batting; and if needed a stitch backing layer, the high loft batting comprising a base layer comprising 30 to 80 parts by weight heat resistant fibers, 5 to 55 parts by weight of a cellulose fiber that retains at least 10 percent of its fiber weight when heated in air to 700° C. at a rate of 20 degrees C. per minute, and 15 to 25 parts by weight of a first binder material; and an outer layer comprising up to 85 parts by weight of a fiber that is either a cellulose fiber that retains at least 10 percent of its fiber weight when heated in air to 700° C. at a rate of 20 degrees C. per minute, a modacrylic fiber, or mixtures including these fibers, and 15 to 25 parts by weight of a second binder material; the base layer comprising 20 to 70 parts by weight and the outer layer comprising 80 to 30 parts by weight of the batting, based on the total weight of those two layers, the batting having a total thickness of at least 0.5 inches (1.25 centimeters),
b) sewing the layers together to form a fire blocked quilted composite or upholstery fabric, and
c) incorporating the fire blocked quilted composite or upholstery fabric into the article.

The layered high loft batting of this invention can be incorporated mattresses, foundations, and/or box springs as a flame blocking layer. For example, the panels and the borders of mattresses, foundations, and/or box springs can utilize the previously described mattress panel quilted composite or any other variant that incorporates as a component the layered high loft batting of this invention. The stitching can be sewn with non-flame retardant thread, however, a fire-retardant thread, such as one made from Kevlar® aramid fiber, is preferred for the stitching, especially for stitching of the borders of the mattresses, foundations, and/or box springs.

### TEST METHODS

ThermoGravametric Analysis. The fibers used in this invention retain a portion of their fiber weight when heated to high temperature at a specific heating rate. This fiber weight was measured using a Model 2950 Thermogravimetric Analyzer (TGA) available from TA Instruments (a division of Waters Corporation) of Newark, Del. The TGA gives a scan of sample weight loss versus increasing temperature. Using the TA Universal Analysis program, percent weight loss can be measured at any recorded temperature. The program profile consists of equilibrating the sample to 50 degrees C., placing the sample in a 500 microliter ceramic cup (PN 952018.910) sample container and ramping the temperature of the air, as measured by a thermocouple placed directly above the lip of the sample container, at 20 degrees C. per minute from 50 to 1000 degrees C., using air supplied at 10 ml/minute. The testing procedure is as follows. The TGA was programmed using the TGA screen on the TA Systems 2900 Controller. The sample ID was entered and the planned temperature ramp program of 20 degrees per minute selected. The empty sample cup was tared using the tare function of the instrument. The fiber sample was cut into approximately 1/16″ (0.16 cm) lengths and the sample pan was loosely filled with the sample. The sample weight should be in the range of 120 to 60 mg. The TGA has a balance therefore the exact weight does not have to be determined beforehand. None of the sample should be outside the pan. The filled sample pan was loaded onto the balance wire making sure the thermocouple is close to the top edge of the pan but not touching it. The furnace is raised over the pan and the TGA is started. Once the program is complete, the TGA will automatically lower the furnace, remove the sample pan, and go into a cool down mode. The TA Systems 2900 Universal Analysis program is then used to analyze and produce the TGA scan for percent weight loss over the range of temperatures.

Thickness. Thickness of the layered batting was measured using ASTM D5736-95 (Reapproved 2001).

Thermal Performance Temperature. The thermal insulating properties of these properties at high temperatures and heat fluxes was then measured using the same instrument that is used for the NFPA1971 Standard on Protective Ensemble for Structural Fire Fighting 2000 Edition Section 6-10. In order to characterize the materials of this invention, the instrument was operated in a data acquisition mode. A 2 cal/cm²/second (8.38 J/cm²/second) heat flux was imposed on the fabric for 90 seconds. During this time, the heat passing through the materials was measured using a calorimeter placed in direct contact with the back face (base layer) of the specimen. The materials were characterized in terms of the temperature of the calorimeter thermocouple at the end of the 90 seconds exposure. This value is directly proportional to the amount of heat that passed through the barrier fabric.

Basis Weight. Basis weight of the batting was measured using ASTM D6242-98.

### EXAMPLES

A two-layered high loft batting having a base layer and an outer layer was made, the fibers in both layers being held in place by use of a copolymer PET sheath/PET core binder fiber having a melting temperature of about 120° C. The base layer, excluding any recycled material, contained Type 970 Kevlar® aramid fiber (available from DuPont) having an individual filament denier of 2.25 denier per filament (2.5 dtex per filament) and an average 1.9 inch (25 mm) cut length, Type 33AP Visil® cellulose fiber (available from Sateri) having an individual filament denier of 3.5 denier per filament (3.9 dtex per filament) and an average 2 inches (50 mm) cut length, and the binder fiber (available from Nan Ya) having an individual filament denier of 4 denier per filament (4.4 dtex per filament) and an average cut length of 2 inches (51 mm). The outer layer had the same Visil® cellulose fiber as the base layer, Protex C modacrylic fiber (available from Kaneka) having an individual filament denier of 7 denier per filament (7.8 dtex per filament) and an average cut length of 2 inches (51 mm), and the same binder fiber as the base layer.

Conventional carding lines/garnet machines and crosslappers were used to open and blend the fibers and form the individual high loft batting layers, which were combined together and heat set using a gas-fired oven. The high loft batting was then cooled. A portion of the high loft batting was recycled back into the cards and the fibers from this recycled portion became part of the base layer.

Data for the high loft batting of this invention are shown in Items 1-10 and data for comparative high loft battings are shown in Items A-D of Table 1. All of the items had a thickness in the range of approximately 0.5 to 1.5 in (1.3 to 3.8 cm). The TPT was then measured for the Items and the results are shown in Table 2. The thermal performance temperature as a function of the total basis weight of the comparative and example items is shown is FIG. 1. From this plot it is clear that the items of this invention lie below the relationship defined by the comparative items and therefore, provide higher thermal protection (lower thermal performance temperature) at a given basis weight.

TABLE 1

| | total | Base Layer | | | | | | Top Layer | | | | |
|---|---|---|---|---|---|---|---|---|---|---|---|---|
| | basis | basis | Compostion, % by weight | | | | | basis | Composition, % by weight | | | |
| item | weight, | weight, | | | | binder | | weight, | | | binder | |
| # | g/m² | g/m² | Kevlar ® | Visil ® | modacrylic | fiber | polyester | g/m² | Visil ® | modacrylic | fiber | polyester |
| A | 271 | 136 | 23 | 45 | 5 | 24 | 3 | 136 | 0 | 0 | 20 | 80 |
| B | 339 | 169 | 23 | 45 | 5 | 24 | 3 | 169 | 0 | 20 | 20 | 60 |
| C | 380 | 190 | 23 | 45 | 5 | 24 | 3 | 190 | 0 | 20 | 20 | 60 |
| D | 475 | 237 | 30 | 50 | 0 | 20 | 0 | 237 | 0 | 50 | 20 | 30 |
| 1 | 441 | 169 | 30 | 50 | 0 | 20 | 0 | 271 | 40 | 40 | 20 | 0 |
| 2 | 610 | 339 | 30 | 50 | 0 | 20 | 0 | 271 | 40 | 40 | 20 | 0 |
| 3 | 402 | 201 | 51 | 28 | 2 | 19 | 0 | 201 | 40 | 40 | 20 | 0 |
| 4 | 374 | 187 | 51 | 28 | 2 | 19 | 0 | 187 | 40 | 40 | 20 | 0 |
| 5 | 535 | 267 | 51 | 28 | 2 | 19 | 0 | 267 | 40 | 40 | 20 | 0 |
| 6 | 319 | 159 | 51 | 28 | 2 | 19 | 0 | 159 | 40 | 40 | 20 | 0 |
| 7 | 442 | 221 | 51 | 28 | 2 | 19 | 0 | 221 | 40 | 40 | 20 | 0 |
| 8 | 497 | 248 | 51 | 28 | 2 | 19 | 0 | 248 | 40 | 40 | 20 | 0 |
| 9 | 390 | 195 | 51 | 28 | 2 | 19 | 0 | 195 | 40 | 40 | 20 | 0 |
| 10 | 432 | 216 | 51 | 28 | 2 | 19 | 0 | 216 | 40 | 40 | 20 | 0 |
| 11 | 410 | 205 | 51 | 28 | 2 | 19 | 0 | 205 | 40 | 40 | 20 | 0 |

TABLE 2

| item # | Temperature, ° C. |
|---|---|
| A | 313 |
| B | 282 |
| C | 274 |
| D | 245 |
| 1 | 233 |
| 2 | 158 |
| 3 | 178 |
| 4 | 257 |
| 5 | 164 |
| 6 | 251 |
| 7 | 185 |
| 8 | 187 |
| 9 | 202 |
| 10 | 227 |
| 11 | 213 |

What is claimed is:

1. A high loft flame resistant batting, comprising:
(a) a base layer comprising
(i) 30 to 80 parts by weight heat resistant fibers,
(ii) 5 to 55 parts by weight of a cellulose fiber that retains at least 10 percent of its fiber weight when heated in air to 700° C. at a rate of 20 degrees C. per minute, and
(iii) a first binder material;
(b) an outer layer comprising
(i) up to 85 parts by weight of a fiber that is either a cellulose fiber that retains at least 10 percent of its fiber weight when heated in air to 700° C. at a rate of 20 degrees C. per minute, a modacrylic fiber, or mixtures thereof, and
(ii) a second binder material; the base layer comprising 20 to 70 parts by weight and the outer layer comprising 80 to 30 parts by weight of the batting, based on the total weight of those two layers, the batting having a total thickness of 0.5 inches (1.25 centimeters) or greater.

2. The high loft flame resistant batting of claim 1 wherein the heat resistant fiber is an organic fiber that retains 90 percent of its fiber weight when heated in air to 500° C. at a rate of 20 degrees C. per minute.

3. The high loft flame resistant batting of claim 1 wherein the heat-resistant fiber comprises a para-aramid, polybenzazole, polybenzimidazole, or polyimide polymer.

4. The high loft flame resistant batting of claim 3 wherein the para-aramid is poly(paraphenylene terephthalamide).

5. The high loft flame resistant batting of claim 1 wherein the cellulose fiber is a viscose fiber containing silicic acid.

6. The high loft flame resistant batting of claim 1 having a density of 0.3 to 4.3 pounds per cubic foot (5 to 70 kilograms per cubic meter).

7. The high loft flame resistant batting of claim 1 having a basis weight of 8 to 18 ounces per square yard (271 to 610 grams per square meter).

8. The high loft flame resistant batting of claim 7 having a basis weight of 11 to 16 ounces per square yard (373 to 542 grams per square meter).

9. The high loft flame resistant batting of claim 1 wherein heat resistant fibers are present in the base layer in the amount of 25 to 35 parts by weight.

10. The high loft flame resistant batting of claim 1 wherein cellulose fibers are present in the base layer in the amount of 45 to 55 parts by weight.

11. The high loft flame resistant batting of claim 1 wherein the base layer further contains modacrylic fibers in the amount of up to 5 parts by weight.

12. The high loft flame resistant batting of claim 1 wherein the cellulose or modacrylic fibers are present in the outer layer in the amount of 35 to 45 parts by weight.

13. The high loft flame resistant batting of claim 1 wherein the first and second binder material is the same binder material.

14. The high loft flame resistant batting of claim 1 wherein the first or second binder material is a binder fiber.

15. An article comprising the high loft flame resistant batting of claim 1 as a fire blocking layer.

16. A mattress comprising the high loft flame resistant batting of claim 1 as a fire blocking layer.

17. A method of fire blocking an article, comprising the steps of
a) combining a layer of a fabric ticking or upholstery, and a high loft batting, and optionally foam and combustible fiber batting; and if needed a stitch backing layer, the high loft batting comprising a base layer comprising 30 to 80 parts by weight heat resistant fibers, 5 to 55 parts by weight of a cellulose fiber that retains at least 10 percent of its fiber weight when heated in air to 700° C. at a rate of 20 degrees C. per minute, and a first binder material; and an outer layer comprising up to 85 parts by weight of a fiber that is either a cellulose fiber that retains at least 10 percent of its fiber weight when heated in air to 700° C. at a rate of 20 degrees C. per minute or a modacrylic fiber, and a second binder material; the base layer comprising 20 to 70 parts by weight and the outer layer comprising 80 to 30 parts by weight of the batting, based on the total weight of those two layers, the batting having a total thickness of at least 0.5 inches (1.25 centimeters),
b) sewing the layers together to form a fire blocked quilted composite or upholstery fabric, and
c) incorporating the fire blocked quilted composite or upholstery fabric into the article.

18. The method of claim 17 wherein the first and second binder material is the same material.

19. The method of claim 17 wherein the first or second binder material is a binder fiber.
